(19) United States
(12) Patent Application Publication
(10) Pub. No.: US 2003/0001884 A1
(43) Pub. Date: Jan. 2, 2003

(54) Method and apparatus for selecting links in internet content on a television

(76) Inventor: Meng-Hsien Liu, Taoyuan (TW)

Correspondence Address: J.C. Patents, Inc., Suite 250, 4 Venture, Irvine, CA, 92618, US

(21) Appl. No.: 09/940,354

(22) Filed: Aug. 27, 2001

Related U.S. Application Data
(60) Provisional application No. 60/290,474, filed on May 11, 2001.

(51) Int. Cl. G09G 5/00

(52) U.S. Cl. 345/738; 345/716; 725/37; 707/513

(57) ABSTRACT

An apparatus and method for selecting links on a television-internet system. A television is connected to a web appliance having an internet connection. Internet content is loaded by the web appliance which proceeds to analyze the internet content identifying links therein. The internet content is then modified with identifiers corresponding the links. The modified document is then displayed on the television. A user can input an identifier and select a corresponding link.

### CROSS-REFERENCE TO RELATED APPLICATION

This application claims the priority benefit of U.S. provisional application serial No. 60/290,474, filed May 11, 2001.

### FIELD OF THE INVENTION

The present invention relates to a method and apparatus for viewing internet on a television, and more specifically a method and apparatus for selecting links in internet content displayed on a television.

### BACKGROUND OF INVENTION

Use of the internet is becoming ever more widespread, and increasingly important in our daily lives. The internet allows users unparalleled access to information around the world via its huge network of connected computers. Most internet users use the World Wide Web WWW to access information whether it be text, sound, images, etc. Currently the majority of internet users use personal computers consisting of high speed microprocessors, accompanying peripherals, high definition computer monitors, and modems connected to telephone lines or other communications means. However there still exists a large segment of the population (more so in less developed countries) that do not have access to personal computers or to the internet. Many of these households however do have a television and an ability to connect to the internet (e.g. phone line). Even for people who do have a personal computer, exploring the internet in the same way they view television can be very appealing due to factors such as greater comfort. Therefore a need exists for an internet device that can display information on a normal television screen. Many problems exist with the implementation of this idea however. In a typical computer environment, computer users choose to explore the internet using a mouse wherein a representative object such as a cursor can have its movement on a graphical interface controlled by hand movement. The representative object can be placed over specialized areas on the screen called links and though the clicking of a button on the mouse an object can be chosen. A keyboard is also used for typing website addresses, search keywords, tabbing between links and so forth. Television users view their television for entertainment purposes and typically do not find it convenient to use a computer mouse or keyboard. Some current systems for selecting links displayed on a television include tabbing between links, or using modified pointing devices to move a cursor on the television screen. These methods however are cumbersome to use, or require a dedicated effort that many television viewers find undesirable. Therefore a need exists for a simple convenient method for selecting internet links on a television-internet system.

### SUMMARY OF THE INVENTION

A primary goal of the invention is to provide a method and apparatus for selecting links on a television-internet system.

The basic system consists of a television connected to a web appliance. The web appliance is connected to the internet and can display internet content on the television. The web appliance has a remote control. In a preferred embodiment of the invention as internet content passes through the web appliance, links are located and identifiers added, each link given a corresponding identifier. The identifier can appear beside a link, or in another embodiment can be superimposed over the link. The modified internet content is then displayed for viewing. A user can input an identifier and the corresponding link will be chosen by the web appliance.

### BRIEF DESCRIPTION OF DRAWINGS

FIG. 1 shows an example of an internet-television system;

FIG. 2 shows a flowchart exemplifying a preferred embodiment of the invention;

FIG. 3 shows an example web page with identifiers appearing beside the links; and

FIG. 4 shows an example web page with identifiers appearing superimposed over the links.

### DETAILED DESCRIPTION

In the following detailed description of the preferred embodiments, reference is made to the accompanying drawings which form a part hereof, and in which is shown by way of illustration specific preferred embodiments in which the invention may be practiced. The preferred embodiments are described in sufficient detail to enable these skilled in the art to practice the invention, and it is to be understood that other embodiments may be utilized and that logical, changes may be made without departing from the spirit and scope of the present invention. The following detailed description is, therefore, not to be taken in a limiting sense, and the scope of the present invention is defined only by the appended claims.

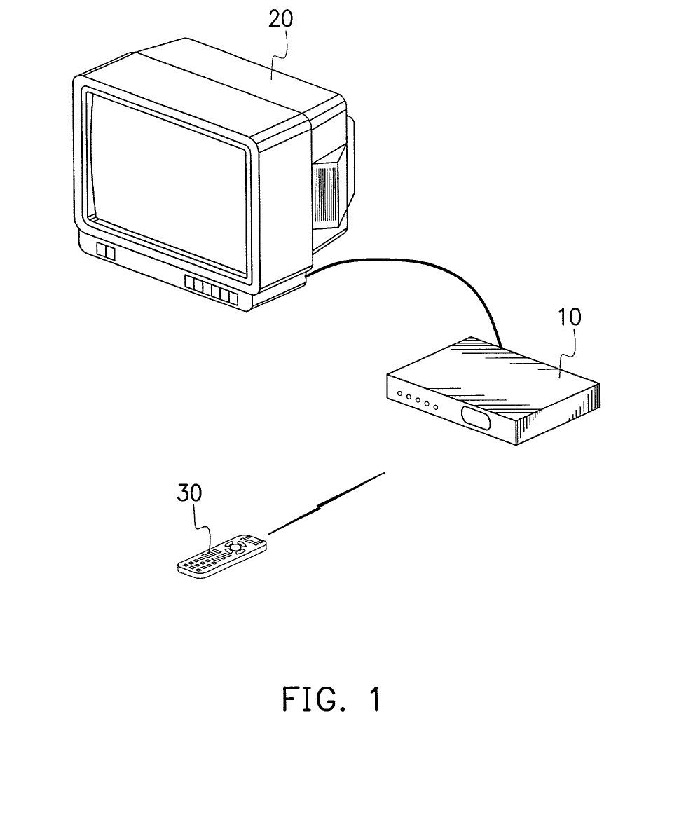

The present invention deals with a method of displaying information on a standard television screen commonly known as “Web television” or “Internet television”. FIG. 1 shows one configuration for the system. A television 20 is connected to a web appliance 10 typically through an audio-video cable. Someone skilled in the art will recognize that the web appliance signal can also be provided to the television through a television signal input. The web appliance 10 is connected to an internet connection. The internet connection can be though phone lines, coaxial cable, RF and so forth. With the web appliance 10 a viewer can watch television as normal, or can activate the web appliance 10 and view the internet through the television. In addition, a viewer can also have the capability to combine television viewing with the internet through interactive programming guides and the linking of web content to television content. The web appliance 10 has an accompanying remote control 30. Typically remote controls are small battery powered devices with a plurality of buttons having different functions. The remote control of the invention can transmit signals using infrared, or alternatively RF signals.

The World Wide Web is the dominant multimedia information retrieval system on the internet. The internet includes a massive collective of documents that are linked together. Most information (e.g. text, graphics, images, sound, video etc.) are transferred using a Hypertext Transfer Protocol (HTTP). HTTP further uses a standard page description language known as Hypertext Markup Language (HTML). HTML is used for marking documents to indicate how a document should be displayed, and how multiple documents should be linked together. For linking the World Wide Web utilizes an addressing scheme known as URLs, or Uniform Resource Locators to find the location of files and documents from computers on the internet. URLs typically consist of an identifier for the type of internet server, an internet address, and a file path to a particular item of interest whether it be text, graphics, video etc. Links usually appear as highlighted text known as the anchor of the link or as pictures, icons, or graphics which can be selected.

The following is an example of HTML code with the links highlighted:

<div id=“Layer2” style=“position:absolute; left:570px; top:200px;
width:88px; height:61px; z-index:2”><α
href=“http://www.leadtek.com”><img src=“images/pro/proline/usa.jpg”
width=“48” height=“69” alt=“USA” border=“0”></a><b><font
color=“#FFFF00”><a href=“http://www.leadtek.com” class=“all”><font
size=“2” face=“Arial, Helvetica, sans-
serif”>USA</font></a></font></b></div>
<div id=“Layer3” style=“position:absolute; left:571px; top:283px;
width:63px; height:58px; z-index:3” class=“all”><a
href=“http://www.leadtek.com.cn”><img
src=“images/pro/proline/china.jpg” width=“70” height=“41” alt=“China”
border=“0”></a><b><font color=“#FFFF00” size=“3”><a
href=“http://www.leadtek.com.cn” class=“all”><font face=“Arial, Helvetica,
sans-serif”>China</font></a></font></b></div>
<div id=“Layer4” style=“position:absolute; left:493px; top:280px;
width:64px; height:103px; z-index:4”>

<p class=“all”><a href=“http://www.leadtek.nl”><b><font size=“3”

color=“#FFFF00”></font></b><img src=“images/pro/proline/europe.jpg”
width=“56” height=“63” alt=“Europe” border=“0”></a><br>

<font size=“3”><b><font color=“#FFFF00”><a

href=“http://www.leadtek.nl” class=“all”><font face=“Arial, Helvetica,
sans-serif”>Europe</font></a></font></b></font>

From the above HTML source code the number, type, and position of the links can be determined as highlighted above.

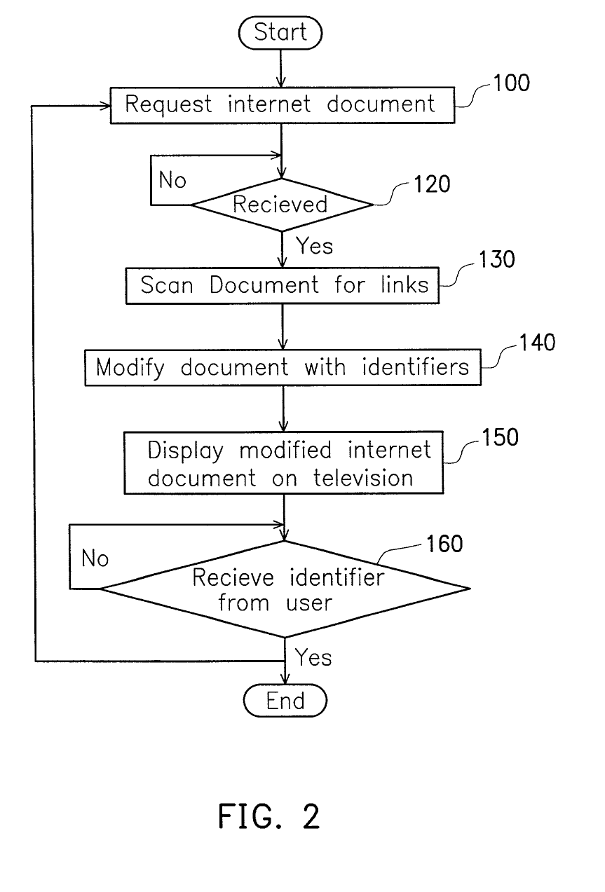

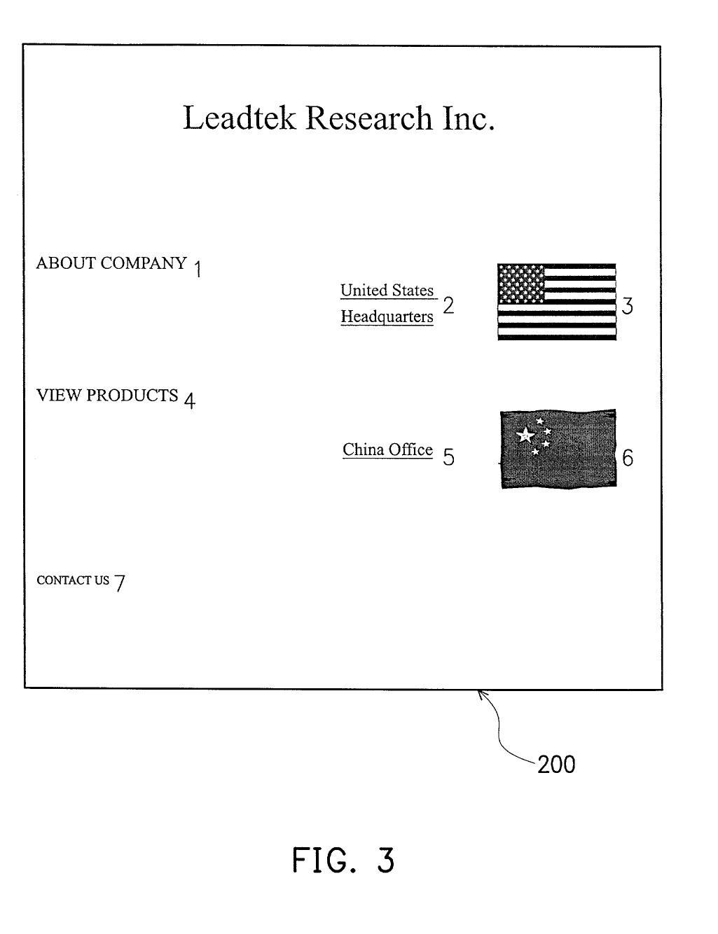

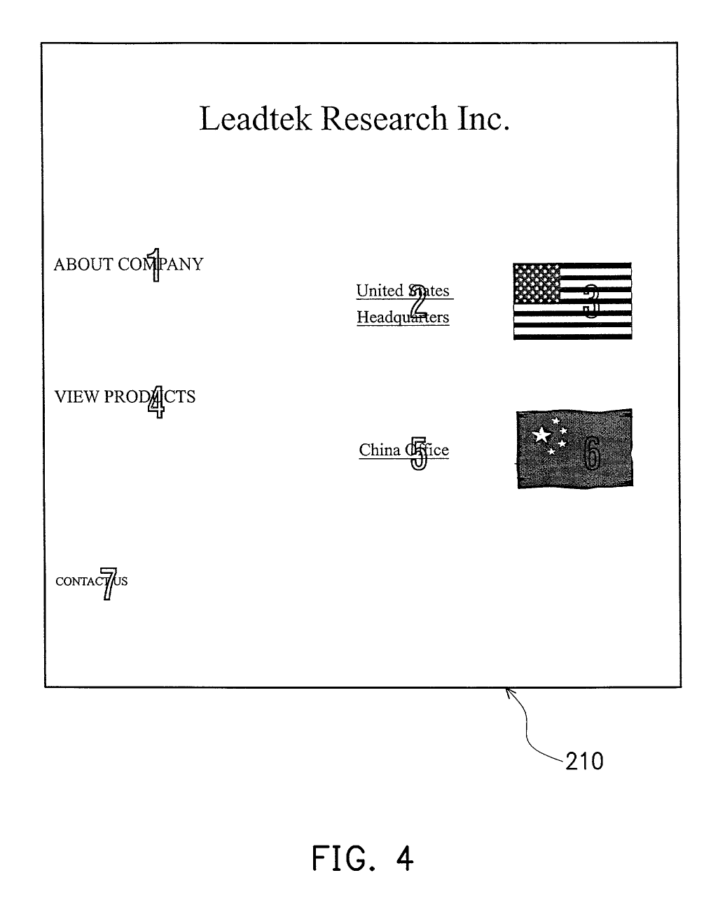

A preferred embodiment is shown in FIG. 2. The web appliance 10 requests an internet document in step 100. After the document is received the web appliance 10 scans the document for links (step 130). The web appliance 10 then modifies the internet document by adding identifiers to each of the links in the document (step 140). In a preferred embodiment of the invention the identifiers are added by modifying the HTML code, although the invention is not limited to this method. Identifiers can be added to the final visual output in a variety of ways such as manipulating the visual signal output in an output buffer. The modified document is then displayed on a television screen (step 150). Once an internet document has been displayed on the television screen, a user can input an identifier (typically using a remote control) to choose a link. The web appliance 10 waits for an identifier or other command to be inputted by a user (step 160). If an identifier is entered the web appliance 10 goes to the identified link returning to step 100. The identifier can appear in a variety of colors, fonts, and locations around the displayed link. The identifier can further be superimposed over the link. FIG. 3 shows fictitious web page 200, with the identifiers indicated as reference numerals 1-7 appearing beside each of the links including texts of “ABOUT COMPANY”, “United States Headquarters”, “VIEW PRODUCT”, “China Office”, and “CONTACT US”, and graphics of US flag and China flag in the web page. FIG. 4 shows fictitious web page 210 with the identifiers 1-7 appearing superimposed over each of the above-mentioned links.

Various additional modifications may be made to the illustrated embodiments without departing from the spirit and scope of the invention. Therefore, the invention lies in the claims hereinafter appended.

What is claimed is:

1. A television-based internet viewing system comprising:
a web appliance with an internet connection;
a television screen displaying internet content from the web appliance;
a plurality of links in the internet content with corresponding identifiers added by the web appliance displayed on the television screen; and
a remote control device in which a desired identifier can be transmitted by a user, wherein the web appliance is responsive to the identifier entered to perform the step of selecting the corresponding link.

2. The system of claim 1, wherein the identifier is a number.

3. The system of claim 1, wherein the identifiers are added by modifying the HTML code of the internet content.

4. The system of claim 1, wherein the identifiers are added in an output buffer for the television signal.

5. A web appliance comprising:
an internet connection for inputting and outputting internet content;
an associated remote control device;
an output to a viewing device;
wherein when internet content is inputted to the web appliance identifiers corresponding to the links contained within the internet content are added and the modified internet content is outputted to the viewing device, the web appliance further responsive to inputted identifiers by the remote control device as to select a corresponding link.

6. The web appliance of claim 5, wherein the identifier is a number.

7. The web appliance of claim 5, wherein the identifiers are added by modifying the HTML code.

8. The web appliance of claim 6, wherein the identifiers are added in an output buffer for the viewing device.

9. An internet television system, comprising:
a television screen,
a web appliance including:
means for analyzing a web document for links;
means for modifying the web document by adding identifiers corresponding to the links;
means to output the modified web document to the television screen; and
means to select a link based on an inputted identifier from a user.

10. The system of claim 9, wherein the identifier is inputted though a remote control corresponding to the web appliance.

11. The system of claim 9, wherein the identifier is a number.

12. A method for selecting links in internet content on a television screen comprising the steps of:
analyzing internet content to determine location of links in a web page;
adding identifiers corresponding to the links in the internet content;
displaying the modified internet content on a viewing device; and
selecting a link when a corresponding identifier is inputted by a user.
